(19) United States
(12) Patent Application Publication
(10) Pub. No.: US 2007/0150946 A1
(43) Pub. Date: Jun. 28, 2007

(54) Method and apparatus for providing remote access to an enterprise network

(75) Inventors: Niklas Hanberger, Stockholm (SE); Johan Bevemyr, Sollentuna (SE)

Correspondence Address: JOHN C. GORECKI, ESQ., P.O BOX 553, CARLISLE, MA, 01741, US

(73) Assignee: Nortel Networks Limited, St. Laurent (CA)

(21) Appl. No.: 11/316,719

(22) Filed: Dec. 23, 2005

(51) Int. Cl. G06F 15/16

(52) U.S. Cl. 726/15

(57) ABSTRACT

VPN tunnels may be established using an Internet browser and dynamically downloadable VPN client software that may be installed as part of a remote login process. By causing the VPN client software to be dynamically downloaded during the session, the remote user does not need to pre-load any software onto the computer that will be used as the remote computer. Thus, any computer with an Internet browser may be used to log into the enterprise network without first requiring the user of that computer to acquire rights to install a VPN client on the computer. By causing some or all of the dynamically downloaded software components to be deleted upon termination of the session, the components of the software may be made to be not available once the session has ended. Encrypted UDP may be used to transmit data on the VPN tunnel where exchange of an initial UDP packet indicates the availability of UDP connectivity.

### BACKGROUND OF THE INVENTION

1. Field of the Invention

The present invention relates to communication networks and, more particularly, to a method and apparatus for providing remote access to an enterprise network.

2. Description of the Related Art

Data communication networks may include various routers, switches, bridges, hubs, and other network devices coupled to and configured to pass data to one another. These devices will be referred to herein as “network elements.” Data is communicated through the data communication network by passing protocol data units, such as Internet Protocol (IP) packets, Ethernet Frames, data cells, segments, or other logical associations of bits/bytes of data, between the network elements by utilizing one or more communication links between the devices. A particular protocol data unit may be handled by multiple network elements and cross multiple communication links as it travels between its source and its destination over the network.

It is common for an enterprise, such as a corporation, educational institution, government, or other type of association, to have a communication network established over which individuals working for the enterprise or associated with the enterprise may transmit data. Enterprise networks are commonly referred to as Local Area Networks (LANs). Access to a LAN is generally restricted, so that only those users that have authenticated themselves to the network and are authorized to obtain access to the network are allowed to communicate over the network and use resources available on the network.

Since access to an enterprise network is restricted, communications within the network are generally viewed as relatively secure. Outside of the network, this is not necessarily the case and, hence, Virtual Private Networks (VPNs) have been developed. VPNs provide a way of creating tunnels through an untrusted network such as the Internet so that network users may be connected to an enterprise network in a secure manner from remote locations. VPN tunnels may also be used to connect different sites of the communication network, for example where the network is deployed in different corporate sites that must be interconnected over a public network such as the Internet.

Although VPN tunnels are commonly used outside of an enterprise network, it takes a reasonable amount of effort to distribute software to the end users, and to maintain that software, so that the users may obtain access to the corporate network. Specifically, conventionally it was necessary for a user that wanted to have remote access to a corporate network to install a special software package on their personal computer. Over time, the software being used by the enterprise may be upgraded or changed, which would similarly cause the software on the remote computers to need to be upgraded as well. Since maintaining software on user machines may become relatively costly and time consuming, it would be advantageous to implement another way of providing remote access to an enterprise network.

### SUMMARY OF THE INVENTION

The present invention overcomes these and other drawbacks by providing a method and apparatus for providing remote access to an enterprise network. According to an embodiment of the invention, VPN tunnels may be established using an Internet browser and dynamically downloadable VPN client software that may be installed on a remote computer as part of the login process when the user logs into the network. By causing the VPN client software to be dynamically downloaded during the session, the remote user does not need to pre-load any software onto the computer that will be used as the remote computer. Thus, any computer with an Internet browser may be used to log into the enterprise network without first requiring the user of that computer to acquire rights to install a VPN client on the computer. By causing some or all of the dynamically downloaded software components to be deleted upon termination of the session, the components of the software may made to be not available once the session has ended so that subsequent computer users will not be able to use the downloaded components to obtain access to the enterprise network at a later point in time.

According to another aspect of the invention, encrypted UDP may be used to transmit data on a VPN tunnel where exchange of an initial UDP packet indicates the availability of UDP connectivity.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example of a network in which remote users are able to obtain remote access to an enterprise network according to an embodiment of the invention;

FIG. 2 is a flow chart illustrating an example of a process of providing remote access to an enterprise network according to an embodiment of the invention;

FIG. 3 is a functional block diagram of a VPN gateway that may be used to implement an embodiment of the invention; and

FIG. 4 is a functional block diagram of a remote computer that may be used to implement an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

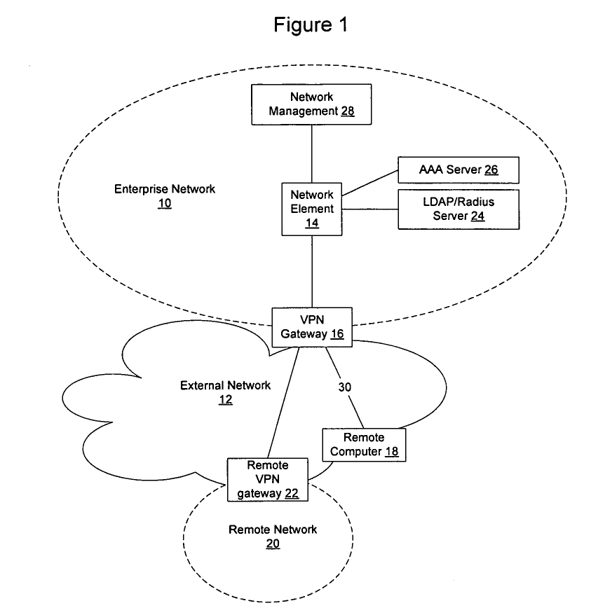

FIG. 1 shows an example enterprise network 10 connected to an external network 12. The enterprise network 10 may be an Ethernet network or may be formed using any number of other LAN technologies. The external network may be the Internet, another network domain, or another type of public network. The invention is not limited to use in connection with a particular type of network.

The enterprise network 10 includes network elements such as routers or switches 14 connected together to enable data to be transmitted within the enterprise network. The enterprise network may have many components, such as e-mail servers, hosts, resources, and other common network elements which are not shown in this example. The invention is not limited to use with an enterprise network configured in any particular manner and, accordingly, details of the internal structure of the enterprise network have been omitted from FIG. 1 to avoid obfuscation of the invention.

The enterprise network 10 may include a VPN gateway 16 configured to provide VPN services to remote users 18 and remote networks 20 so that communications may be exchanged securely between the enterprise network 10 and the remote computer 18 associated with the remote user or remote network 20. VPN gateways are well known and the invention is not limited to a particular embodiment in which particular types of external resources are used. The VPN gateway 16 enables a remote user to use a remote computer 18 to obtain remote access to the enterprise network 10 across the external network 12 in a secure way, for example by supporting creation of VPN tunnels between the remote computer and the enterprise network. Optionally, a remote VPN gateway 22 may be associated with the remote network 20 to establish tunnels for use in connection with connecting the remote network 20 to the enterprise network 10.

The enterprise network 10 may have one or more internal servers configured to work in connection with the VPN gateway to enable remote computers to securely connect to the enterprise network 10. For example, the enterprise network 10 may include an LDAP/Radius server 24 configured to provide remote access to the network, e.g. to enable a remote user to use a remote computer 18 to log onto the network. The network may also have an AAA server 26 configured to authenticate users logging onto the network and determine whether the users are authorized and, optionally, an authorization level of the user.

A network management station 28 may be included to enable a network manager to set policy on the network. For example, the network administrator may set policy determining which remote users should be provided with remote access, and to set any other parameters associated with providing remote access onto the network 10. Configuring a network to enable remote users to obtain network access may be done in many different ways and the invention is not limited to a particular way in which the network is set up to authenticate users and otherwise determine how users should be provided with network access. To provide context for description of an embodiment of the invention, several additional details will be provided. The invention is not limited to the use of this particular example as other example network architectures may be used to provide access to remote network users as well.

When a remote computer 18 connects to the network, depending on the manner in which the connection occurs, the remote computer will communicate with the LDAP/Radius server 24 and/or the AAA server 26 to perform standard authentication and authorization procedures. Optionally, a computer configuration verification process may be performed as well, such as to determine whether the remote computer has the proper antivirus files, authorized versions of applications, and otherwise is correctly configured. Computer configuration verification may be performed in a standard manner and the invention is not limited to any particular manner in which the configuration verification is performed.

Commonly, when a remote user wanted to obtain remote access to an enterprise network, the remote user would need to install VPN client software on the remote computer 18 that was to be used to access the network. For example, in the example shown in FIG. 1, the remote user would need to install a VPN client on the remote computer 18 to enable the remote computer to connect to the enterprise network on a VPN tunnel 30. Since the VPN client software was specifically installed on a particular computer, if the user wanted to obtain access from a different computer, the user would need to install the VPN client software on that new computer. For example, if an user wanted to log into the corporate network from home, the user would need to install VPN client software on their home computer, often reboot the computer to cause the installation to take effect, and then use the VPN client to access the network. If the user was traveling without a computer in which the VPN client had been installed, VPN access was often not feasible.

To overcome these limitations, according to an embodiment of the invention, VPN tunnels may be established using an Internet browser and dynamically downloadable VPN client software, e.g. via Java or ActiveX controls. By causing the VPN client software to be dynamically downloaded during a session, the remote user does not need to pre-load any software onto the computer that will be used as the remote computer. Thus, any computer with an Internet browser may be used to log into the enterprise network without first requiring the user of that computer to acquire rights to install software on the computer. By causing some or all of the dynamically downloaded software components to be deleted upon termination of the session, the components of the software may made to be not available once the session has ended so that the method may be used to obtain access to a corporate network even from a publicly available computer.

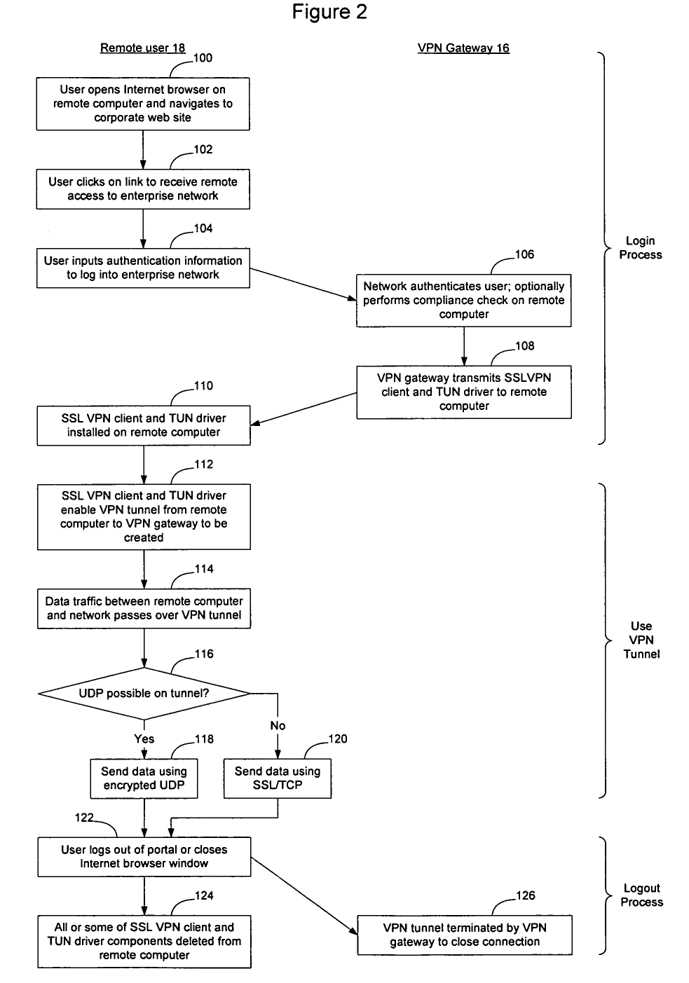

FIG. 2 illustrates an example of a process that may be used to obtain access to an enterprise network from a remote location according to an embodiment of the invention. The invention is not limited to this particular series of actions, however, as other processes may be used to establish a VPN tunnel between a remote user and a VPN gateway, use the VPN tunnel, and then terminate the VPN tunnel. Accordingly, the invention is not limited to a process that implements all of these described actions or only these particular actions.

As shown in FIG. 2, when a remote user wishes to obtain remote access to an enterprise network, the user will cause the remote computer 18 to boot and will open an Internet browser (76) on the remote computer. Once the Internet browser is opened, the user will navigate to an Internet site associated with the enterprise (100). If the front page accessed at the enterprise web site contains a link to a login page, the remote user will click on the link to cause the remote user login page to be displayed through which the remote user may obtain access to the enterprise network (102). Otherwise, the user may navigate to the remote access login page to locate the link to be used to log into the network remotely, and click onto the remote login link.

The enterprise network login page through which the user may log into the enterprise network may be created using conventional techniques. For example, the login page may include instruction information instructing the user how to log in and may include one or more fields configured to enable the remote user to enter login information such as user ID and password information. Optionally, the login page may also include a field for entry of token information, such as to enable the user to input the value of a time-varying code known to both the user and the enterprise network. The invention is not limited to the use of particular fields or to the use of a particularly configured graphical user interface, as many different presentation formats and fields may be used to collect relevant information from the remote user to enable the remote user to be authenticated to the network.

Once the user reaches the login page, the user will input the information requested by the login page to enable the user to be authenticated to the network (104). The information input by the user will be sent to the network gateway or VPN gateway, which will interface a LDAP/RADIUS server 24 and/or AAA server 26 to determine whether the user is authorized to access the network, whether remote access for this user should be authorized, and to otherwise perform any other processes required to determine an authorization level for the user that is attempting to log into the network. Optionally, the network gateway may also perform a compliance check to see whether the remote computer being used to log into the network is infected with any malicious code or has a configuration that would make it undesirable to allow the remote computer to access the enterprise network. (106).

If the user is authenticated to the network, the user is authorized to access the network remotely, and the remote computer passes the compliance check, the network gateway will transmit to the remote computer software that may be used to implement a VPN tunnel with the VPN gateway (108). The software may be dynamically installed automatically using Java, Active X controls, or another type of software, and may include both a Secure Socket Layer (SSL) Virtual Private Network (VPN) client and TUN driver. Other software packages may be used as well and the invention is not limited to the use of these particular software components or to the use of Java or ActiveX controls to download the software package.

The SSL VPN client is a client that will be used to create a VPN tunnel between the remote computer and the VPN gateway to support encryption of the traffic on the tunnel. Optionally, since the SSL VPN client is being installed by the remote computer for a particular session, the SSL VPN client may be pre-programmed with appropriate keys to be used during that session. Thus, a key-exchange protocol need not occur between the remote computer and VPN gateway since the keys may already be assigned and exchanged when the SSLVPN client is transmitted to the remote computer. Alternatively, the SSL VPN client may be installed and then a key exchange process may be used to establish the tunnel in a conventional manner. Many commercially available SSL VPN clients have been developed and the invention is not limited to the use of any particular SSL VPN client.

The TUN driver is a process that enables traffic to be passed to a tunnel interface rather than to a physical interface at the remote computer. In operation, when data is to be transmitted from an application on the remote computer, the data will be passed to the TUN driver instead of the physical interface. The TUN driver will support the VPN tunnel at the application layer and will pass the data to the user mode client software which handles encryption and eventual compression. The TUN driver will pass the data to the network interface after it has been encrypted or otherwise encapsulated so that the network interface may send the data over the tunnel to the VPN gateway. TUN drivers are well known software components and the invention is not limited to the use of a particular TUN driver.

The remote computer will install the software package (such as the SSLVPN client and TUN driver) (110). The SSL VPN client and TUN driver are configured to enable a VPN tunnel to be created from the remote computer to the VPN gateway to enable the remote user to be provided with remote access to the enterprise network, so that the remote user has access to the enterprise network in the same manner as would have been possible had the user permanently installed the SSL VPN client and TUN driver on the remote computer (112). Since the remote user has access to the enterprise network, the remote user may access corporate e-mail, participate in net-meetings, access corporate documents and databases, and otherwise perform functions on the remote computer that would otherwise be available if the remote user was connected to the enterprise network directly. As the remote user interacts on the enterprise network, data traffic between the remote computer and the enterprise network will pass over the VPN tunnel (114) to remain secure even while passing over the public external network 12.

Optionally, where the network intermediate the remote user and the VPN gateway are able to support User Datagram Protocol (UDP), UDP may be used to transmit data over the tunnel. UDP is preferable for multi-media applications and other applications that are less tolerant of jitter and delay in transmission on the network. To make this determination, the SSL VPN client will probe the connectivity between the client and the server to determine if UDP packets are able to be transmitted on the tunnel (116). If UDP is supported, then the IP packets will be sent over the tunnel via encrypted UDP (118). If UDP packets are not allowed to be exchanged between the SSL client and the VPN gateway, the data will be sent using Secure Socket Layer (SSL)/Transmission Control Protocol (TCP) (120).

For example, in operation the VPN gateway will have one or more (such as two) UDP ports through which clients may connect to obtain remote access to the network. The VPN gateway will notify the remote computer of the UDP port number during the log-in process. Once the UDP port number is known, the remote client will create a probe packet which is a 1500 byte dummy IP packet. The remote client will encrypt the dummy packet and send it to the VPN gateway. If the packet is successfully received and decrypted by the VPN gateway, then it is echoed to the client. Encrypted UDP connectivity may be assumed once the client sends the first IP packet over encrypted UDP.

The encryption, in this instance, may take the form of a Hashed Method Authentication Code (HMAC) over the packet, and the actual data may be encrypted using the same bulk encryption algorithm as is used for the SSL connection. The same shared secret may thus be used for secure UDP as was used for the SSL session. A serial number may also be included with each packet to avoid replay attacks.

After a certain number of bytes has been sent, or after a given time, an SSL renegotiation may occur. The renegotiation may be initiated by the client on its own or as instructed by the VPN gateway. Once renegotiation has started, packet transmission will be put on hold until the renegotiation has completed. The new secret exchanged during the SSL renegotiation may be used to encrypt UDP packets as well.

To maintain the session alive, a heartbeat signal may be transmitted between the client and server. Regardless of UDP connectivity, the heartbeat will be sent to enable the TPC/SSL connectivity to be maintained. If the VPN gateway does not receive a heartbeat signal from the client for two minutes (or another selected time period) the client may be considered dead and the connection may be closed.

When the client is mobile, if the client is disconnected and later reconnects with the same session ID, it will get the same tunnel IP. If the client reconnects using a different session ID but requests a specific tunnel IP, the client may be assigned the same tunnel IP as well. By enabling mobility to be handled, the virtual tunnel interface at the client may remain up and all packets dropped until the connection is re-established.

Upon termination of the session, for example if the user logs out of the portal or closes the Internet browser window (122), all or some of the SSLVPN client components and TUN driver components will be deleted from the remote computer (124). By deleting the components, or at least some of the components, the software that was downloaded to enable remote access to the enterprise network may be prevented from being used from a subsequent user of that computer. For example, if the remote computer is a publicly available computer in an Internet café, kiosk, airport terminal, or other publicly available computer, removal of the software components may prevent a subsequent user from re-establishing the tunnel when the remote user moves away from the remote computer. Although all components may be removed, optionally some components may be allowed to remain indefinitely or for a finite period of time to enable a reconnection to occur more quickly. This may be useful, for example where the remote user accidentally terminated the session by closing the Internet browser window associated with the session.

Optionally, the remote user may provide input as to whether any components should remain on the computer upon logout, so that the user may help determine whether the computer is a public computer that is likely to be used by other persons or is a private computer and, hence, less likely to be available for use by other persons. For example, the remote user may use different links into the VPN gateway depending on whether the user is accessing the network from a public computer or a private computer. Depending on the manner in which the remote user has elected to connect to the system, different termination processes may be used to selectively remove components from the remote computer. The invention is not limited in this manner, however, as a determination as to which components are to remain on the remote computer upon termination of the session may also be set by policy by the network administrator.

When the session is terminated, the VPN tunnel will be shut down by the VPN gateway so that the connection between the remote user and the enterprise network may be closed (126). The VPN gateway may operate in a conventional manner to close the tunnel. Optionally, the VPN gateway may send a message to the software that was installed on the remote computer to cause all or some of the software components to be deleted from the remote computer as discussed above. Alternatively, the components may be configured such that, upon determination that the VPN tunnel has gone down or that the session has terminated, the components may immediately or a short time thereafter, start to remove themselves from the computer. Accordingly, the software components downloaded during the login process may be provided with a self-destruct mechanism whereby the software will automatically delete all or a portion of the downloaded software components upon termination of the session. The invention is not limited to the manner in which the software decides or is instructed to remove itself from the remote computer.

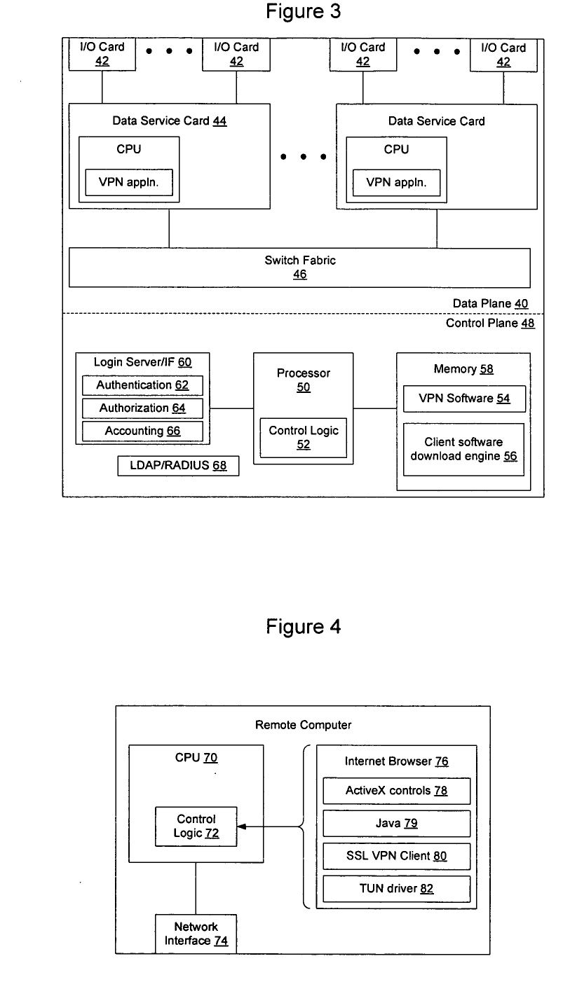

FIG. 3 illustrates an example of a VPN gateway according to an embodiment of the invention. The invention is not limited to this embodiment, as the VPN gateway may be implemented in many ways without departing from the scope of the invention.

As shown in FIG. 3, the VPN gateway may include a data plane 40 configured to handle data communications on the network. The data plane may include, for example, I/O cards 42 containing ports configured to connect to physical links on the network, which may be supported by one or more data service cards 44. A switch fabric 46 may enable packets received over one of the ports to be switched to one or more of the other ports. By selective connection of the ports to the external network and the enterprise network, data may be switched between the two networks selectively.

The data plane 40 is supported by a control plane 48 that controls establishment of VPN tunnels through the VPN gateway. The VPN tunnels may be implemented on the data plane by causing appropriate encryption, compression, and/or encapsulation processes to be instantiated on the data service cards, e.g. via VPN application 50, so that the VPN tunnels may be terminated at the VPN gateway. The data service cards, in this instance, support instantiation of applications so that the tunnels may be terminated at the VPN gateway. The invention is not limited in this manner, however, as other components may support implementation of the tunnels as well.

The control plane 48 includes a processor 50 configured to implement control logic 52 that will enable it to perform functions as discussed in greater detail above in connection with FIGS. 1-2. For example, the control logic may be configured to implement VPN software 54 and client software download engine 56. The data and instructions associated with the VPN software 54 and client software download engine 56 may be stored in memory 58 available to processor 50. The client software download engine 56, in this embodiment, is configured to enable software components to be downloaded to remote users during the login process as described above. The VPN software 54 and client software download engine 56 are thus configured to enable the VPN gateway to participate in admitting the remote users to the network, causing VPN software to be downloaded to and installed on the remote computers, and establishing VPN tunnels with the remote users. The VPN gateway may be configured to perform these functions itself or may be configured to interface with one or more external servers designed to perform aspects of these processes.

The VPN gateway also includes a client software download engine configured to download and install client software packages to remote computers as they connect to the network. For example, the client software download engine may be configured to download and install the VPN SSL client and TUN driver using Active X controls or Java. The invention is not limited in this manner, however, as other forms of downloading these components may be used and additional or different components may also be downloaded by the client software download engine.

Optionally the VPN gateway may be configured to provide the services conventionally provided by a RADIUS/LDAP server and/or an AAA server. For example, in the embodiment shown in FIG. 3, the VPN gateway includes a login server/login server interface 60 containing an authentication module 62 configured to authenticate users, devices, or connections on the network, an authorization module 64 configured to determine appropriate authorization control information to prevent unauthorized access to the network, and an accounting module 66 configured to enable accounting entries to be established for communication sessions on the network. Similarly, the VPN gateway may also include a LDAP/RADIUS server to control remote access to the network. The invention is not limited to a VPN gateway that performs all or some of these services as the VPN gateway may also rely on external servers to perform some or all of these functions.

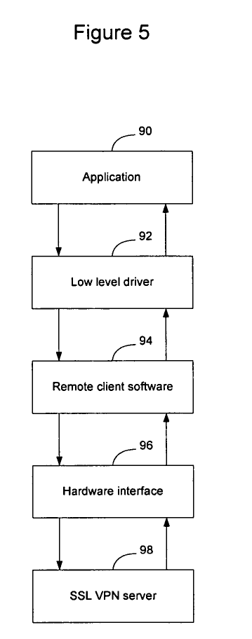

FIG. 4 illustrates a remote computer that may be configured to implement an embodiment of the invention. For ease of explanation, the embodiment shown in FIG. 4 is shown in the state where the dynamically installed VPN software has been installed so that the remote computer is ready to communicate using a tunnel on the network. As discussed above, once the session has completed, some or all of the VPN software components will be removed from the computer to return the remote computer to a normal configuration.

In the embodiment shown in FIG. 4, the remote computer 18 includes a processor 70 running control logic 72. The remote computer connects to a network via network interface 74. The control logic, in this embodiment, is configured to implement a web browser 76 running ActiveX controls 78 or Java 79. According to an embodiment of the invention, a SSL VPN client 80 and a TUN driver 82 are loaded into the context of the Web browser 76 that is open within a particular window on the remote computer. The SSL VPN client 80 and TUN driver 82 are components that were loaded during a log-in process when the Web browser was used to log into the network. When the window in which the web browser is run is closed, the remote access session between the remote computer and the enterprise network will be terminated. Termination of the session will cause the context of the window to be deleted which, in turn, will cause all or some of the transiently loaded software components to be deleted from the remote computer.

FIG. 5 illustrates the data flow between an application 90, such as a web browser, and the to the SSL VPN server 98. As shown in FIG. 5, when data is generated by an application 90 such as a web browser, it is passed to a low level driver 92 and then to the remote client software 94. The low level driver 92 and the remote client software 94 may be downloaded as part of the software package when the user logs onto the network. The data is then passed from the remote client software to a hardware interface 96 in the computer, which passes the data to the SSL VPN server 98 to be encrypted. On the reverse path, when data is received from the network, the data will pass through the same functional blocks in the reverse order.

The functions described above may be implemented as a set of program instructions that are stored in a computer readable memory 66 and executed on one or more associated processors. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of providing remote access to an enterprise network, the method comprising the steps of:
opening a web browser to create a session;
navigating to a log-in page associated with an enterprise network;
submitting a request to log in to the enterprise network;
receiving a software package to be used to secure communications with the enterprise network during the session, at least part of the software package configured to be loaded in the context of the session and deleted upon termination of the session.

2. The method of claim 1, wherein the software package is configured to implement a Virtual Private Network (VPN) client.

3. The method of claim 2, wherein the software package contains a Secure Socket Layer (SSL) Virtual Private Network (VPN) client and a TUN driver.

4. The method of claim 1, further comprising the step of loading the software package using ActiveX controls.

5. The method of claim 1, further comprising the step of loading the software package using Java.

6. The method of claim 1, wherein the step of submitting a request comprises transmitting authentication information.

7. The method of claim 1, further comprising sending a User Datagram Protocol (UDP) probe packet to a gateway associated with the enterprise network.

8. The method of claim 1, further comprising determining whether UDP connectivity is available and, if UDP connectivity is available, performing a step of communicating with the enterprise network using encrypted UDP.

9. The method of claim 1, further comprising the step of using the software package to create a Virtual Private Network (VPN) tunnel to secure communications with the enterprise network during the session.

10. The method of claim 9, wherein traffic on the VPN tunnel is sent using encrypted User Datagram Protocol (UDP).

11. The method of claim 1, further comprising the step of removing at least part of the software package upon termination of the session.

12. The method of claim 11, wherein the step of removing at least part of the software package comprises removing all of the software package upon termination of the session.

13. A method of enabling remote clients to interface with an enterprise network in a secure manner, the method comprising the steps of:
receiving a request for access to the enterprise network from a remote computer; and
transmitting a software package to be used to secure communications between the remote computer and the enterprise network during a communication session between the remote computer and the enterprise network, at least part of the software package configured to be loaded in the context of the session and deleted upon termination of the session.

14. The method of claim 13, further comprising the step of establishing at least one User Datagram Protocol (UDP) port configured to be used to communicate with the remote computer using encrypted UDP.

15. The method of claim 14, further comprising the steps of receiving a UDP probe packet from the remote computer, and echoing the UDP probe packet to the remote computer.

16. The method of claim 13, further comprising the step of encrypting traffic on the communication session and transmitting the encrypted traffic to the remote computer.

17. The method of claim 13, further comprising authenticating a user associated with the remote computer.

18. The method of claim 13, wherein the software package comprises a Secure Socket Layer (SSL) Virtual Private Network (VPN) client and a TUN driver.

19. The method of claim 18, further comprising establishing a VPN tunnel with the remote computer and using a SSL secret to encrypt User Datagram Protocol (UDP) traffic on the VPN tunnel.
